(19) United States
(12) Patent Application Publication
(10) Pub. No.: US 2019/0368642 A1
(43) Pub. Date: Dec. 5, 2019

(54) PIPE JOINT

(71) Applicant: NITTA CORPORATION, Osaka-shi, Osaka (JP)

(72) Inventors: Shuichi SAGA, Nabari-shi, Mie (JP); Masafumi MATSUMOTO, Nabari-shi, Mie (JP); Masafumi HAYASHI, Nabari-shi, Mie (JP)

(21) Appl. No.: 16/481,510

(22) PCT Filed: Nov. 1, 2017
(86) PCT No.: PCT/JP2017/039572

§ 371 Date: Jul. 29, 2019

(30) Foreign Application Priority Data
Jan. 30, 2017 (JP) 2017-014328

(51) Int. Cl. F16L 37/34

(52) U.S. Cl. CPC F16L 37/34

(57) ABSTRACT

A pipe joint including a female joint capable of further reliably preventing leakage of a fluid is provided. The pipe joint includes: a female joint; and a male joint configured to be inserted into the female joint. The female joint includes: a female joint body; a distribution pipe provided in the female joint body, the distribution pipe having a first orifice; a sleeve configured to move in an axial direction between the female joint body and the distribution pipe for opening and closing of the first orifice; and an elastic portion configured to press the sleeve toward a distal end side of the female joint body, the sleeve includes a first seal portion configured to seal a gap between the sleeve and the distribution pipe when the sleeve closes the first orifice, and the distribution pipe includes: a first seal surface sealed by the first seal portion; and a tapered surface slanted from a base end side of the distribution pipe toward the first seal surface with respect to the axial direction.

### TECHNICAL FIELD

The present invention relates to a pipe joint.

### BACKGROUND ART

A pipe joint including a male joint and a female joint is disclosed, the male joint being inserted into the female joint for connection (e.g., Patent Literature 1). The female joint of Patent Literature 1 includes a center shaft, a main poppet provided behind a head of the center shaft and movable back and forth, and a sub poppet provided to be movable back and forth while sealing outer peripheries of the head of the center shaft and the main poppet. This female joint is opened as the sub poppet moves rearward with respect to the center shaft while sealing the outer periphery to press down the main poppet.

### CITATION LIST

### Patent Literature

Patent Literature 1: Japanese Patent Laid-Open No. 2007-177859

### SUMMARY OF INVENTION

### Technical Problem

When closing the pipe joint of Patent Literature 1, the sub poppet moves from the main poppet to the head of the center shaft while continuously sealing the outer peripheries thereof, so that friction resistance is high. If a spring force of a coil spring for pressing the sub poppet forward is not sufficient, the sub poppet stops before the head of the center shaft, resulting in failure to close the female joint.

An object of the present invention is to provide a pipe joint including a female joint capable of further reliably preventing leakage of a fluid.

### Solution to Problem

According to the present invention, a pipe joint includes: a female joint; and a male joint configured to be inserted into the female joint. The female joint includes: a female joint body; a distribution pipe provided in the female joint body, the distribution pipe having a first orifice; a sleeve configured to move in an axial direction between the female joint body and the distribution pipe to close the first orifice; and an elastic portion configured to press the sleeve toward a distal end side of the female joint body, the sleeve includes a first seal portion configured to seal a gap between the sleeve and the distribution pipe when the sleeve closes the first orifice, and the distribution pipe includes: a first seal surface sealed by the first seal portion; and a tapered surface slanted from a base end side of the distribution pipe toward the first seal surface with respect to the axial direction.

### Advantageous Effects of Invention

According to the present invention, the first seal portion of the female joint comes into contact with the tapered surface before the first seal surface, thereby closing the first orifice. The female joint can thus reliably prevent leakage of a fluid even if the sleeve fails to fully return to an original point.

### BRIEF DESCRIPTION OF DRAWINGS

FIG. 1 is a partial cross-sectional view showing a configuration of a pipe joint according to the present embodiment.

FIG. 2 is a partial cross-sectional view showing a configuration of a female joint.

FIG. 3 is an enlarged partial cross-sectional view of the female joint.

FIG. 4 is a partial cross-sectional view showing a configuration of a male joint.

FIG. 5 is an enlarged partial cross-sectional view of the male joint.

### DESCRIPTION OF EMBODIMENT

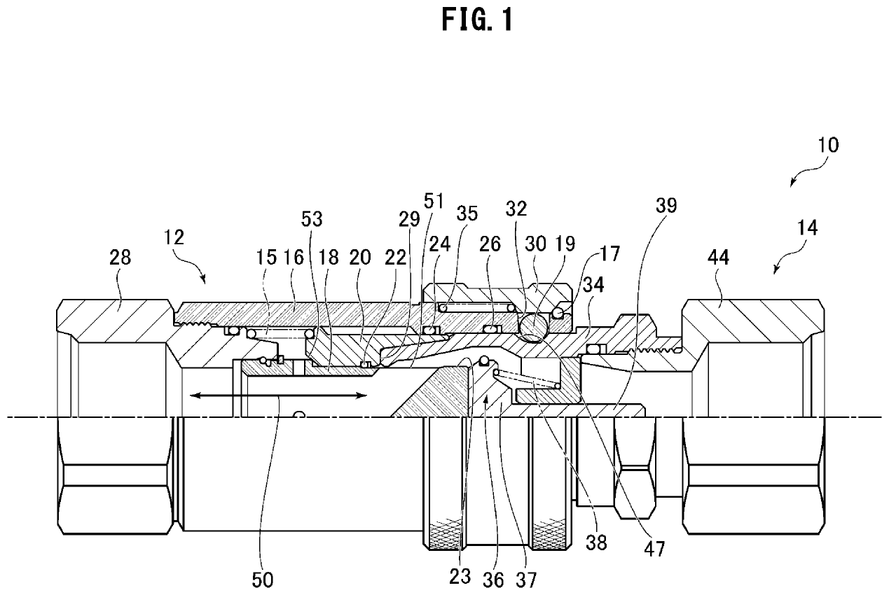

An embodiment of the present invention will be described in detail with reference to drawings. A pipe joint 10 shown in FIG. 1 is a quick joint including a female joint 12 and a male joint 14 being inserted into the female joint 12.

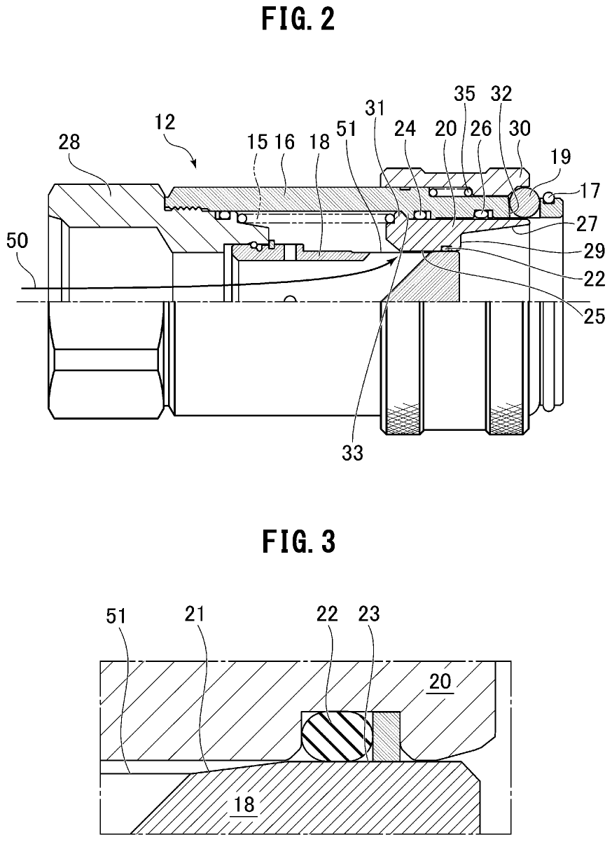

As shown in FIG. 2, the female joint 12 includes a metal female joint body 16, a metal distribution pipe 18 provided in the female joint body 16, and a metal sleeve 20 configured to move in an axial direction between the female joint body 16 and the distribution pipe 18 for opening and closing of a first orifice 51.

The female joint body 16 includes a first cap 28 at a base end thereof and an operating body 30 at a distal end thereof. The female joint body 16 is a cylindrical member with a base end that has an inner peripheral surface provided with a female thread. The first cap 28, which has an outer peripheral surface provided with a male thread, is screwed in the female thread to be fixed to the female joint body 16. The distal end of the female joint body 16 has an outer peripheral surface where a snap ring 17 is attached. The operating body 30 is in contact with the snap ring 17 and held on the female joint body 16. The operating body 30 is pressed in a distal direction by a coil spring 35 (elastic portion) provided between the operating body 30 and the female joint body 16. The female joint body 16 has a through hole 32 penetrating in a thickness direction at a distal end side thereof and a sphere 19 fitted in the through hole 32. The through hole 32 is in a tapered shape from outside toward inside of the female joint body 16 so that the sphere 19 is prevented from falling inside the female joint body 16.

The distribution pipe 18, which is a columnar member, has a flow path 50 penetrating from a center of a base end toward a first orifice 51 of a side surface at the other end. The base end of the distribution pipe 18 is fixed to the first cap 28.

The sleeve 20, which is a cylindrical member, includes a first inner periphery 25, a second inner periphery 27 having an inner diameter larger than an inner diameter of the first inner periphery 25, and an abutting portion 29 formed between the first inner periphery 25 and the second inner periphery 27. The sleeve 20 is pressed toward the distal end of the female joint body 16 by the coil spring 15 (elastic portion) provided between the sleeve 20 and the first cap 28. The sleeve 20 is held in the female joint body 16 by contact of a claw 31 provided to an outer peripheral surface of the sleeve 20 with a first annular projection 33 provided to the inner peripheral surface of the female joint body 16.

A gap between the sleeve 20 and the female joint body 16 is sealed by a third seal portion 24 provided to the inner peripheral surface of the female joint body 16. The third seal portion 24 is continuously in contact with the outer peripheral surface of the sleeve 20 throughout a process of the axial movement of the sleeve 20. A fourth seal portion 26 is provided to the inner peripheral surface of the female joint body 16 at a position closer to the distal end than the third seal portion 24. The fourth seal portion 26 is to come into contact with a seal surface of a later-described male joint body 34. In the present embodiment, the fourth seal portion 26 is not in contact with the outer peripheral surface of the sleeve 20. It should be noted that the seal portion herein is preferably a squeeze packing. For instance, an O-ring, a D-ring with a D-shaped cross section, an X-ring with an X-shaped cross section, and a T-ring with a T-shaped cross section are usable.

As shown in FIG. 3, the distribution pipe 18 has, at a distal end thereof, a first seal surface 23 and a tapered surface 21 between the first seal surface 23 and the first orifice 51. The tapered surface 21 is slanted from a base end side thereof toward the first seal surface 23 with respect to the axial direction. An inner peripheral surface of the sleeve 20 is provided with a first seal portion 22 that is to come into contact with at least a part of the tapered surface 21 and the first seal surface 23. The sleeve 20 closes the first orifice 51 as the first seal portion 22 comes into contact with the part of the tapered surface 21 or the first seal surface 23. The sleeve 20 opens the first orifice 51 as moving toward the base end side with the first seal portion 22 being separated from the tapered surface 21.

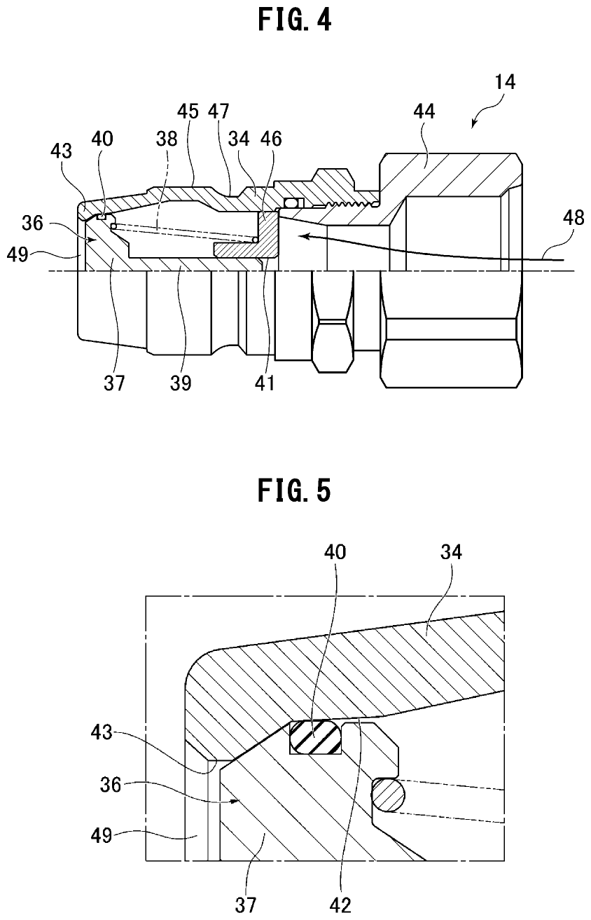

As shown in FIG. 4, the male joint 14 includes the metal male joint body 34 and a metal valve body 36 provided in the male joint body 34 for opening and closing of a second orifice 49.

The male joint body 34 includes the valve body 36 at a distal end thereof and a second cap 44 at a base end thereof. The male joint body 34, which is a cylindrical member, has an outer periphery with an outer peripheral seal surface 45 and an annular recessed portion 47 while having an inner peripheral surface provided with a female thread at the base end thereof. The second cap 44, which has an outer peripheral surface provided with a male thread, is screwed in the female thread to be fixed to the male joint body 34.

The valve body 36, which includes a disk-like valve portion 37 and a shaft portion 39 formed coaxially with the valve portion 37, is pressed in a distal direction by a coil spring 38 (elastic portion) provided between the valve body 36 and a holder portion 46 fixed to the male joint body 34. The holder portion 46 has a support hole 41 supporting the shaft portion 39 such that the shaft portion 39 is movable in the axial direction and a flow path (not shown) penetrating in the axial direction of the male joint body 34.

As shown in FIG. 5, the inner peripheral surface of the male joint body 34 is in a tapered shape toward the distal end thereof, the distal end having a second annular projection 43 and a second seal surface 42 slanted toward the second annular projection 43 with respect to the axial direction. The valve body 36 comes into contact with the second annular projection 43, thereby being held inside the male joint body 34. The valve body 36 has an outer periphery with a second seal portion 40 that is to come into contact with the second seal surface 42. The valve body 36 closes the second orifice 49 as the second seal portion 40 comes into contact with the second seal surface 42.

Next, operations and effects of the pipe joint 10 with the above configuration will be explained. First, a process for connecting the female joint 12 and the male joint 14 will be explained. The first cap 28 and the second cap 44, each of which have the inner peripheral surface provided with the female thread, have respective pipe bodies (not shown) connected thereto. When the female joint 12 is not connected to the male joint 14 with the sleeve 20 being at a position (hereinafter also referred to as “original point”) on the distal end side of the female joint body 16 and the first seal portion 22 being in contact with the first seal surface 23 of the distribution pipe 18, the first orifice 51 is closed, thereby preventing fluid leakage. In the male joint 14, when the valve body 36 is at a position (hereinafter also referred to as “original point”) on the distal end side of the male joint body 34 and the second seal portion 40 being in contact with the second seal surface 42, the second orifice 49 is closed to prevent fluid leakage.

As the male joint 14 is inserted into the female joint 12, the distal end of the male joint body 34 comes into contact with the abutting portion 29 of the sleeve 20. As the male joint 14 is further inserted, the male joint body 34 makes the sleeve 20 recede. As the sleeve 20 further recedes, the first seal portion 22 is separated from the first seal surface 23, thus opening the first orifice 51. In the female joint 12, the third seal portion 24 is in contact with the outer peripheral surface of the sleeve 20, and in the male joint 14, the fourth seal portion 26 is in contact with the outer peripheral seal surface 45. The pipe joint 10 thus prevents leakage of a fluid.

Meanwhile, a distal end of the distribution pipe 18 comes into contact with the valve body 36, making the valve body 36 recede. When the second seal portion 40 is separated from the second seal surface 42, the second orifice 49 is opened.

The sleeve 20 stops when a rear end of the sleeve 20 reaches the stop portion 53 of the distribution pipe 18. In the male joint 14, when the sleeve 20 stops, the sphere 19 moves radially inward and partly enters the annular recessed portion 47. The radially inward movement of the sphere 19 allows the operating body 30 to be movable forward. By moving the operating body 30 toward the distal end, the sphere 19 is fixed and the male joint 14 and the female joint 12 are fixedly connected. The female joint 12 and the male joint 14 of the pipe joint 10 are thus connected to each other with flow paths 48, 50 being in communication with each other.

Next, a process for separating the female joint 12 from the male joint 14 will be explained. The operating body 30 is moved toward the base end side. This allows the sphere 19 to be movable in a radial direction of the female joint body 16. Next, as the male joint 14 is pulled out of the female joint 12, the male joint 14 moves while pressing out the sphere 19 in the radial direction. The sleeve 20 moves forward with the abutting portion 29 kept in contact with the distal end of the male joint 14 until the claw 31 comes into contact with the first annular projection 33 of the female joint body 16. At this time, the first seal portion 22 reaches the first seal surface 23 through the first orifice 51.

If the spring force of the coil spring 15 for pressing the sleeve 20 is not sufficient, contact resistance caused between the first seal portion 22 and the first seal surface 23 makes the sleeve 20 stop before the claw 31 comes into contact with the first annular projection 33, that is, before the original point where the first seal portion 22 comes into contact with the first seal surface 23.

In the present embodiment, the first seal portion 22 of the female joint 12 comes into contact with the tapered surface 21 defined before the first seal surface 23 so as to close the first orifice 51. The female joint 12 can thus reliably prevent leakage of a fluid even if the sleeve 20 fails to fully return to the original point.

Meanwhile, the male joint 14 moves forward with the valve body 36 kept in contact with the distal end of the distribution pipe 18. Since the second seal surface 42 is slanted with respect to the axial direction, the second orifice 49 can be closed when the second seal portion 40 comes into contact with the second seal surface 42 even if the valve body 36 stops before coming into contact with the second annular projection 43, that is, before the original point. The male joint 14 can thus reliably prevent leakage of a fluid even if the valve body 36 fails to fully return to the original point.

The third seal portion 24 is continuously in contact with the outer peripheral surface of the sleeve 20 throughout a process of the axial movement of the sleeve 20, thereby preventing foreign substances from entering between the third seal portion 24 and the outer peripheral surface of the sleeve 20 to further reliably prevent leakage of a fluid from between the female joint body 16 and the sleeve 20.

The female joint 12 includes, in addition to the third seal portion 24, the fourth seal portion 26 to come into contact with the outer peripheral seal surface 45 of the male joint 14, so that no single seal portion crosses an interface between the female joint 12 and the male joint 14 during the movement for connection to or separation from the male joint 14. The pipe joint 10 can thus further reliably prevent leakage of a fluid during the movement for connection to or separation from the male joint 14.

Since the pipe joint 10 includes the third seal portion 24, the fourth seal portion 26 does not need to seal the outer peripheral surface of the sleeve 20. The pipe joint 10 of the present embodiment can thus reduce friction resistance caused when the sleeve 20 moves in the axial direction, since the fourth seal portion 26 is not in contact with the outer peripheral surface of the sleeve 20.

### Modification

The present invention is not limited to the above embodiment but may be modified as needed without departing from the scope of the present invention.

### REFERENCE SIGNS LIST

10 pipe joint

12 female joint

14 male joint

15 coil spring (elastic portion)

16 female joint body

18 distribution pipe

20 sleeve

21 tapered surface

22 first seal portion

23 first seal surface

24 third seal portion

26 fourth seal portion

34 male joint body

36 valve body

38 coil spring (elastic portion)

40 second seal portion

42 second seal surface

45 outer peripheral seal surface

48, 50 flow path

51 first orifice

1. A pipe joint comprising:
a female joint; and
a male joint configured to be inserted into the female joint, wherein
the female joint comprises:
a female joint body;
a distribution pipe provided in the female joint body, the distribution pipe having a first orifice;
a sleeve configured to move in an axial direction between the female joint body and the distribution pipe to close the first orifice; and
an elastic portion configured to press the sleeve toward a distal end side of the female joint body,
the sleeve comprises a first seal portion configured to seal a gap between the sleeve and the distribution pipe when the sleeve closes the first orifice, and
the distribution pipe comprises:
a first seal surface sealed by the first seal portion; and
a tapered surface slanted from a base end side of the distribution pipe toward the first seal surface with respect to the axial direction.

2. The pipe joint according to claim 1, wherein
the male joint comprises:
a male joint body;
a valve body provided in the male joint body; and
an elastic portion configured to press the valve body toward a distal end side of the male joint body,
the valve body comprises a second seal portion configured to seal a gap between the valve body and the distal end of the male joint body when the valve body is closed, and
the male joint body comprises a second seal surface configured to be sealed by the second seal portion, the second seal surface being slanted in the axial direction.

3. The pipe joint according to claim 1, wherein the female joint body comprises:
a third seal portion configured to seal a gap between the female joint body and the sleeve throughout a process of movement of the sleeve in the axial direction; and
a fourth seal portion configured to seal a gap between an outer peripheral seal surface of the male joint and the female joint body when the female joint is connected to the male joint.
